(19) United States
(12) Patent Application Publication
(10) Pub. No.: US 2023/0056270 A1
(43) Pub. Date: Feb. 23, 2023

(54) MOBILE BODY

(71) Applicant: TOYOTA JIDOSHA KABUSHIKI KAISHA, Aichi-ken (JP)

(72) Inventors: Tetsuya KANATA, Toyota-shi (JP); Tomoko ASAI, Nagoya-shi (JP); Kohki BABA, Susono-shi (JP); Kei SATO, Toyota-shi (JP); Takashi HAYASHI, Nagoya-shi (JP); Manabu NAGAI, Nagoya-shi (JP)

(21) Appl. No.: 17/878,054

(22) Filed: Aug. 1, 2022

(30) Foreign Application Priority Data
Aug. 17, 2021 (JP) 2021-132962

(51) Int. Cl. B60L 50/20; B60L 50/60; G06Q 30/02; H02J 7/00

(52) U.S. Cl. CPC B60L 50/20; B60L 50/60; G06Q 30/0207; H02J 7/0063

(57) ABSTRACT

A mobile body includes: a main body provided with a moving function; a storage battery that is disposed in the main body and that stores electric power for driving the main body; a supply unit that supplies electric power to the storage battery; a requesting unit that requests an electric power provider who is able to supply electric power to the storage battery by the supply unit for cooperation in electric power supply; and a granting unit that grants an incentive to the electric power provider that has supplied the electric power to the storage battery by the supply unit. Therefore, when the electric power is insufficient during traveling, the electric power can be supplied to the storage battery by requesting cooperation in electric power supply, and the electric power provider can receive an incentive by supplying the electric power.

### CROSS-REFERENCE TO RELATED APPLICATION

This application claims priority to Japanese Patent Application No. 2021-132962 filed on Aug. 17, 2021, incorporated herein by reference in its entirety.

### BACKGROUND

### 1. Technical Field

The present disclosure relates to a mobile body such as a small mobility vehicle.

### 2. Description of Related Art

Japanese Unexamined Patent Application Publication No. 2003-314437 (JP 2003-314437 A) discloses a health device that generates electric power by a stepping motion of a user. Further, Japanese Unexamined Patent Application Publication No. 2016-106849 (JP 2016-106849 A) discloses a power generation system for calculating an electricity fee of electric power generated by an exercise of a user. In these technologies, electric power is secured in a manner such that the user uses exercise equipment to generate electric power.

### SUMMARY

On the other hand, mobile bodies such as small mobility vehicles that travel on electric power have a relatively short cruising range. Therefore, it is necessary to charge the mobile bodies frequently, and it is necessary to stop the service during the charging time at the charging base. Further, in order to retain the electric power required for traveling, the electric power that can be used for services other than traveling becomes small. Therefore, it is conceivable to install a system that can be charged while driving, but such a system is expensive and costly to install.

In consideration of the above facts, an object of the present disclosure is to obtain a mobile body that can be charged while traveling without relying on an expensive system.

A mobile body according to the present disclosure described in claim 1 includes: a main body provided with a moving function; a storage battery that is disposed in the main body and that stores electric power for driving the main body; a supply unit that supplies electric power to the storage battery; a requesting unit that requests an electric power provider who is able to supply electric power to the storage battery by the supply unit for cooperation in electric power supply; and a granting unit that grants an incentive to the electric power provider who has supplied the electric power to the storage battery by the supply unit.

The mobile body according to the present disclosure described in claim 1 includes: the main body provided with the moving function; the storage battery that is disposed in the main body and that stores electric power for driving the main body; the supply unit that supplies electric power to the storage battery; the requesting unit that requests the electric power provider who is able to supply electric power to the storage battery by the supply unit for cooperation in electric power supply; and the granting unit that grants an incentive to the electric power provider that has supplied the electric power to the storage battery by the supply unit. Therefore, when the electric power is insufficient during traveling, the requesting unit requests the electric power provider for cooperation in the electric power supply, whereby the electric power provider supplies the electric power to the storage battery via the supply unit. Further, the mobile body includes the granting unit that grants an incentive to the electric power provider. Therefore, the electric power provider can receive an incentive by supplying electric power, and thus it is easy to gain cooperation in electric power supply. With the above, the mobile body can be charged during traveling without relying on an expensive system. In the present disclosure, “during traveling” refers to the period during which the mobile body is moving to the destination, and includes the time when the mobile body is stopped.

In the mobile body according to the present disclosure described in claim 2, in the configuration according to claim 1, the supply unit is a power generation device that generates electric power by an exercise of the electric power provider.

In the mobile body according to the present disclosure described in claim 2, the supply unit is the power generation device that generates electric power by exercise of the electric power provider. Therefore, the storage battery can be charged by securing the electric power provider who exercises.

In the mobile body according to the present disclosure described in claim 3, in the configuration according to claim 1 or 2, the granting unit grants the incentive corresponding to the electric power stored in the storage battery.

In the mobile body according to the present disclosure described in claim 3, the granting unit grants the incentive corresponding to the electric power stored in the storage battery. Therefore, the electric power provider can receive the incentive corresponding to the supplied electric power.

In the mobile body according to the present disclosure described in claim 4, in the configuration according to any one of claims 1 to 3, the granting unit grants the incentive corresponding to power consumption.

In the mobile body according to the present disclosure described in claim 4, the granting unit grants the incentive corresponding to the power consumption. For example, when the incentive is increased as the power consumption is larger, it is possible to motivate the electric power provider to provide electric power beyond the concern about the power consumption. On the contrary, when the incentive is increased as the power consumption is smaller, it is possible to further promote the electric power supply by the electric power provider to the storage battery having low power consumption and a high charge-discharge efficiency.

In the mobile body according to the present disclosure described in claim 5, in the configuration according to any one of claims 1 to 4, the supply unit is a power regeneration unit that receives surplus energy generated by an external device and generates regenerative power.

In the mobile body according to the present disclosure described in claim 5, the supply unit is the power regeneration unit that receives surplus energy generated by the external device and generates regenerative power, whereby the storage battery can be charged via the external device.

In the configuration according to claim 5, the mobile body according to the present disclosure described in claim 6, further includes a notification unit that notifies surroundings of a cooperation request for moving to an installation location of the external device.

The mobile body according to the present disclosure described in claim 6 includes the notification unit that notifies the surroundings of the cooperation request for moving to the installation location of the external device. Therefore, when the battery is exhausted before the mobile body reaches the installation location of the external device, the notification unit can request cooperation from the surroundings.

In the mobile body according to the present disclosure described in claim 7, in the configuration according to claim 5 or 6, the power regeneration unit includes a joint standardized with an output unit that is provided in the external device generating the surplus energy and outputs the surplus energy.

The mobile body according to the present disclosure described in claim 7 includes the joint standardized with the output unit provided in the external device generating the surplus energy and that outputs the surplus energy. Therefore, surplus energy of public facilities such as various elevators and escalators can be stored through the joint.

As described above, the mobile body according to the present disclosure has an excellent effect that the mobile body can be charged during traveling without relying on an expensive system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a mobile body according to a first embodiment as viewed from side;

FIG. 2 is a schematic top view of the mobile body according to the first embodiment as viewed from above;

FIG. 3 is a block diagram showing a hardware configuration of the mobile body according to the first embodiment;

FIG. 4 is a block diagram showing a functional configuration of the mobile body according to the first embodiment;

FIG. 5 is a schematic diagram showing a schematic configuration of a mobile body according to a second embodiment;

FIG. 6 is a block diagram showing a functional configuration of the mobile body according to a third embodiment; and

FIG. 7 is a schematic perspective view of a mobile body that is a modification.

### DETAILED DESCRIPTION OF EMBODIMENTS

### First Embodiment

Hereinafter, a mobile body 10 according to a first embodiment of the present disclosure will be described with reference to the drawings. Arrows FR and UP shown in each drawing indicate the traveling direction (forward) of the mobile body 10 and the upper side of the mobile body 10, respectively, and arrows RH and LH indicate rightward and leftward in the width direction of the mobile body 10, respectively.

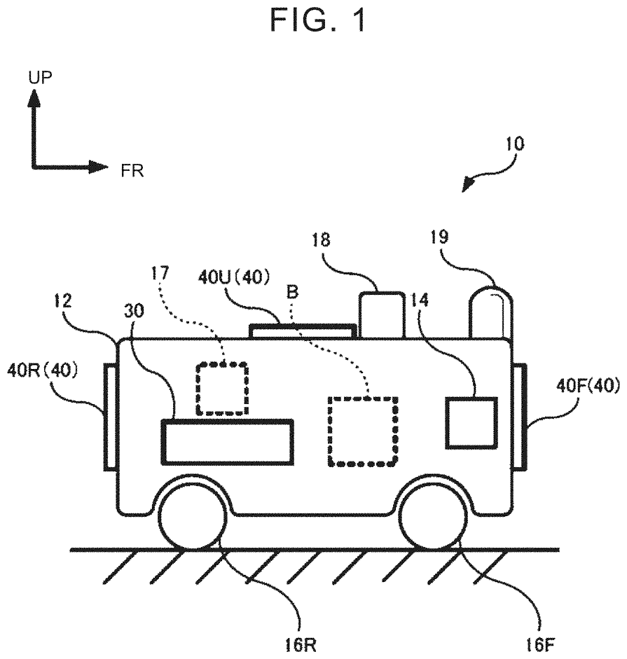

As shown in FIG. 1, the mobile body 10 according to the present embodiment includes a main body 12 and a control unit 14. As an example, the main body 12 has a substantially rectangular shape in side view, and a luggage compartment for accommodating a package B is secured inside the main body 12. Here, as an example, the mobile body 10 according to the present embodiment is a delivery vehicle that delivers packages. Although FIG. 1 shows a state in which one package B is accommodated, the present disclosure is not limited to this, and the configuration in which a plurality of the packages B can be accommodated may be adopted.

The main body 12 includes a pair of right and left front wheels 16F and a pair of right and left rear wheels 16R. Note that, in FIG. 1, only the front wheel 16F and the rear wheel 16R on the right side are shown. Here, the front wheels 16F and the rear wheels 16R are provided with motors (not shown), and the front wheels 16F and the rear wheels 16R are configured to be rotated by a driving force of the motors. That is, the mobile body 10 according to the present embodiment has an in-wheel motor structure.

Further, a battery 17 is provided inside the main body 12, and the front wheels 16F and the rear wheels 16R are independently driven by supplying the electric power stored in the battery 17 to the motors. That is, the mobile body 10 according to the present embodiment is one type of a battery electric vehicle (BEV).

The battery 17 functions as a storage battery for storing electric power. As the battery 17, for example, a lithium ion secondary battery, a lithium ion polymer secondary battery, a nickel hydrogen storage battery, a nickel cadmium storage battery, or the like can be used.

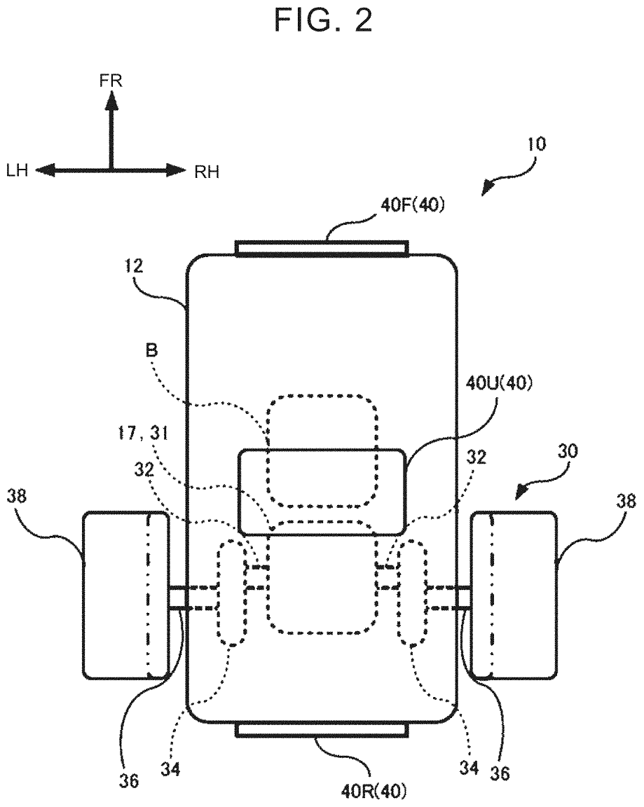

Further, a power generation device 30 as a supply unit for supplying electric power to the battery 17 is connected to the battery 17 below the battery 17. As shown in FIG. 2, first shaft portions 32 for rotating the power generation body (not shown) inside the power generation device main body 31 are provided on the right and left sides of a power generation device main body 31, respectively. A cam 34 is coupled to each of the right and left first shaft portions 32, and a pedal 38 is coupled to each cam 34 via a second shaft portion 36. The main body 12 is provided with holes (not shown) through which the second shaft portions 36 are inserted, and the pedals 38 are coupled to the second shaft portions 36 that are inserted through the holes and protrude outward.

Each pedal 38 is made of a durable synthetic resin or other material, and is configured to be foldable on the side surface side of the main body 12 when not in use. A known structure can be used for the folding structure of the pedal 38.

In the present embodiment, as an example, the power generation body (not shown) inside the power generation device main body 31 is rotated as the user rotates (pedals) the right and left pedals 38 with the feet of the user, that is, as the user exercises, thereby generating the electric power. In the present embodiment, as an example, the user can sit on the upper surface of the main body 12 and pedal the pedals 38.

Further, a peripheral information detection sensor 18 for detecting a peripheral obstacle that is an obstacle around the mobile body 10 is provided in an upper portion of the main body 12. As an example, the peripheral information detection sensor 18 according to the present embodiment is configured to include sensors such as light detection and ranging or laser imaging detection and ranging (LIDAR). Further, the peripheral information detection sensor 18 may be provided with an engineering camera, a radar, or the like.

A communication unit 19 is provided in front of the peripheral information detection sensor 18 in the upper portion of the main body 12, and communicates with the outside.

A front display panel 40F is provided on the front surface of the main body 12, and a rear display panel 40R is provided on the rear surface of the main body 12. Further, an upper surface display panel 40U is provided on the upper surface of the main body 12. The front display panel 40F, the rear display panel 40R, and the upper surface display panel 40U constitute a display unit 40, and each of the front display panel 40F, the rear display panel 40R, and the upper surface display panel 40U displays various types of information. In the present embodiment, as an example, the front display panel 40F, the rear display panel 40R, and the upper surface display panel 40U display various messages. The contents of the messages will be described in detail later.

### Hardware Configuration of Mobile Body 10

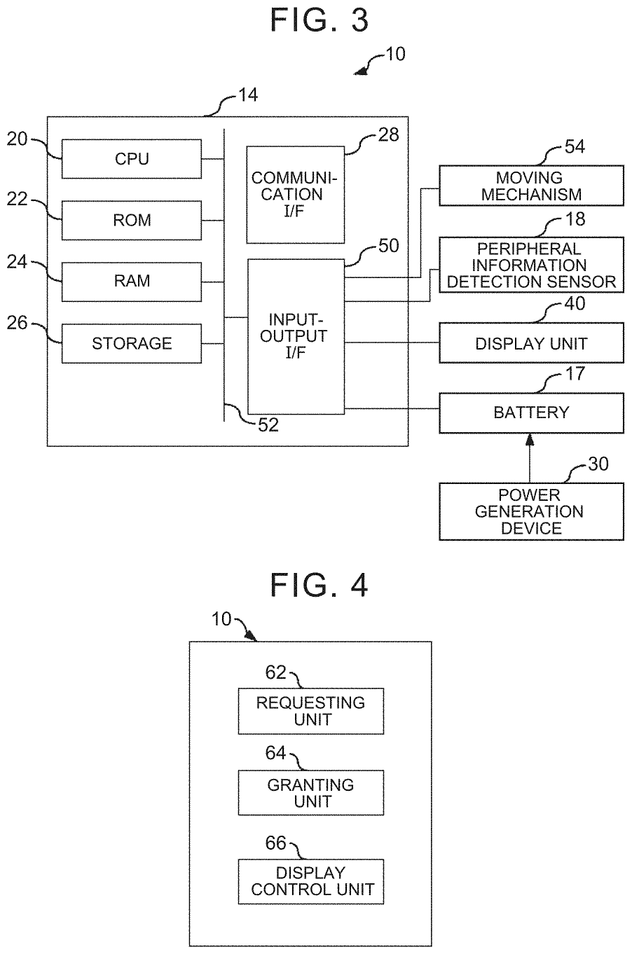

FIG. 3 shows the hardware configuration of the mobile body 10. As shown in FIG. 3, the control unit 14 constituting the mobile body 10 is configured to include a central processing unit (CPU: processor) 20, a read-only memory (ROM) 22, a random access memory (RAM) 24, a storage 26, a communication interface (communication I/F) 28, and an input-output interface (input-output I/F) 30. Each configuration is communicably connected to each other via an internal bus 52.

The CPU 20 is a central processing unit that executes various programs and that controls various units. That is, the CPU 20 reads the program from the ROM 22 or the storage 26 and executes the program using the RAM 24 as a work area. The CPU 20 controls each of the above configurations and performs various arithmetic processes in accordance with the program recorded in the ROM 22 or the storage 26.

The ROM 22 stores various programs and various data. The RAM 24 temporarily stores a program or data as a work area. The storage 26 is composed of a hard disk drive (HDD) or a solid state drive (SSD), stores various programs including an operating system, and stores various data.

The communication I/F 28 is an interface for the mobile body 10 to communicate with other devices, and for example, standards such as a controller area network (CAN), Ethernet (registered trademark), long term evolution (LTE), fiber distributed data interface (FDDI), and Wi-Fi (registered trademark) are used.

The input-output I/F 30 is electrically connected to a moving mechanism 54, the peripheral information detection sensor 18, the display unit 40, and the battery 17. The above-mentioned power generation device 30 is connected to the battery 17.

The moving mechanism 54 is a mechanism for the main body 12 to autonomously travel, and includes a pair of the front wheels 16F, a pair of the rear wheels 16R, a motor (not shown) that transmits the driving force to the front wheels 16F and the rear wheels 16R, and a steering angle control device (not shown) that changes steering angles of the front wheels 16F and the rear wheels 16R.

Further, the control unit 14 controls autonomous traveling of the mobile body 10 according to the present embodiment. Specifically, the control unit 14 generates a traveling plan based on the peripheral information detected by the peripheral information detection sensor 18 and the map information acquired from the server, and controls the moving mechanism 54 such that the mobile body 10 moves in accordance with the generated traveling plan.

### Functional Configuration of Mobile Body 10

The mobile body 10 realizes various functions using the above hardware resources. The functional configuration realized by the mobile body 10 will be described with reference to FIG. 4.

As shown in FIG. 4, the mobile body 10 includes a requesting unit 62, a granting unit 64, and a display control unit 66 as the functional configuration. Each functional configuration is realized as the CPU 20 reads and executes the program stored in the ROM 22 or the storage 26.

The requesting unit 62 requests cooperation in electric power supply to an electric power provider who can supply the electric power to the battery 17 by the power generation device 30. Specifically, the requesting unit 62 detects the electric energy stored in the battery 17. Then, when the detected electric energy reaches, for example, 20% or less, the requesting unit 62 causes the display control unit 66 to display, as an example, a sentence “Please pedal.” on the display unit 40, that is, at least one of the front display panel 40F and the rear display panel 40R. In the present embodiment, as an example, the requesting unit 62 causes both of the front display panel 40F and the rear display panel 40R to display the above sentence.

The granting unit 64 grants an incentive (reward) to the electric power provider who has supplied electric power to the battery 17 by the power generation device 30. Specifically, the granting unit 64 grants a preset incentive for one electric power supply. The incentive may be granted, for example, as electronic money or as points that can be exchanged for valuable resources or paid services. Further, the incentive may be granted as virtual money, a discount ticket, or the like.

The granting unit 64 causes the upper surface display panel 40U to display the incentive granted by the current power supply via the display control unit 66.

Specifically, as an example, the granting unit 64 registers information of a plurality of electric power providers in advance in a server (not shown) that communicates via the communication unit 19, and identifies the current electric power provider by reading the information on the current electric power provider from, for example, a mobile terminal of the electric power provider, and collating the read information with the above information registered in the server. Then, as an example, the incentive can be granted by transferring the incentive to the registered bank account of the electric power provider. Further, the granting unit 64 may grant an incentive on the mobile terminal or the like of the electric power provider as electronic information. The incentive can be granted using known techniques.

Note that, in the present embodiment, the incentive is set in accordance with power consumption of the mobile body 10. As an example, the incentive is increased as the power consumption of the mobile body 10 increases, or the incentive is increased as the power consumption of the mobile body 10 decreases.

The display control unit 66 has a function of displaying various types of information on the display unit 40 (the front display panel 40F, the rear display panel 40R, the upper surface display panel 40U).

### Action and Effect

Next, an action of the first embodiment will be described.

In the mobile body 10 according to the first embodiment, as shown in FIGS. 1 and 3, the main body 12 includes the moving mechanism 54, and the control unit 14 controls the moving mechanism 54 to cause the main body 12 to autonomously travel.

Further, the mobile body 10 according to the first embodiment includes the main body 12, the battery 17, the power generation device 30, and the requesting unit 62. Therefore, when the electric power is insufficient during traveling, the requesting unit 62 requests the electric power provider to cooperate in the electric power supply, specifically, the display unit 40 displays, as an example, the sentence “Please pedal.”, whereby the electric power provider supplies the electric power to the battery 17 via the power generation device 30.

Further, the mobile body 10 according to the first embodiment includes the granting unit 64 that grants an incentive to the electric power provider. Therefore, the electric power provider can receive an incentive by supplying electric power, and thus it is easy to gain cooperation in electric power supply. With the above, the mobile body 10 can be charged during traveling without relying on an expensive system.

Further, since the mobile body 10 according to the first embodiment is a device in which the power generation device 30 generates electric power by the exercise of the user, the battery 17 can be charged by securing the user who exercises.

Further, in the mobile body 10 according to the first embodiment, the granting unit 64 grants an incentive in accordance with the power consumption of the mobile body 10. For example, when the incentive is increased as the power consumption of the mobile body 10 is larger, it is possible to motivate the electric power provider to provide electric power beyond the concern about the power consumption. On the contrary, when the incentive is increased as the power consumption of the mobile body 10 is smaller, it is possible to further promote the electric power supply by the electric power provider to the storage battery having low power consumption and a high charge-discharge efficiency.

Further, in the mobile body 10 according to the first embodiment, the granting unit 64 causes the upper surface display panel 40U to display the incentive grated in response to the current power supply via the display control unit 66. With the above, the electric power provider can confirm the incentive that the electric power provider receives by visually observing the upper surface display panel 40U.

In the first embodiment, the granting unit 64 grants a preset incentive for one electric power supply. However, the present disclosure is not limited to this. The granting unit 64 may grant an incentive in accordance with, for example, the electric power stored in the battery 17, that is, the electric energy provided by the electric power provider. Specifically, the granting unit 64 increases the incentive as the electric energy increases. With the above, the electric power provider can receive an incentive corresponding to the amount of exercise.

Further, in the first embodiment, when the detected electric energy becomes, for example, 20% or less, the requesting unit 62 causes the display control unit 66 to display, as an example, the sentence “Please pedal.” on the display unit 40. However, the present disclosure is not limited to this. The requesting unit 62 may output, as an example, the sentence “Please pedal.” by an audio output device (not shown), for example.

### Second Embodiment

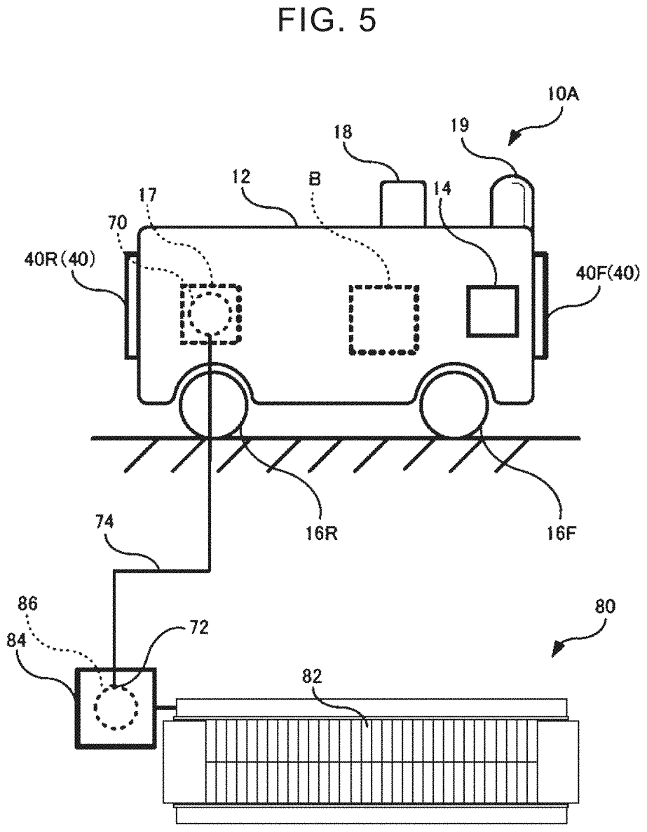

Next, a mobile body 10A according to a second embodiment of the present disclosure will be described with reference to FIG. 5. The same configurations as those of the first embodiment will be described by the same reference symbols, the description thereof will be omitted, and only the different portions will be described in detail.

As shown in FIG. 5, the mobile body 10A according to the second embodiment is provided with a power regeneration unit 70 as the supply unit, unlike the mobile body 10 according to the first embodiment that is provided with the power generation device 30 as the supply unit. The power regeneration unit 70 receives surplus energy generated by an escalator 80 as an external device, generates regenerative power, and stores the generated regenerative power in the battery 17. Specifically, the power regeneration unit 70 generates regenerative power by rotating a motor (not shown) of the moving mechanism 54 using the surplus energy received. Further, the power regeneration unit 70 includes a joint 72 to be joined to an output unit 86 of the escalator 80 that will be described later. The joint 72 will be described in detail later.

The escalator 80 includes a drive unit 84 that continuously raises and lowers a step 82. The drive unit 84 includes a drive device (not shown), a motor that is rotationally driven by the drive device (not shown), a control unit that controls the drive device (not shown), and the like. When three-phase commercial alternating current (AC) power is input to the drive device from a commercial power source (not shown), the motor is rotated and the step 82 is raised and lowered.

In the present embodiment, the drive unit 84 includes, for example, the output unit 86 that outputs the energy generated when the motor regenerates electric power as surplus energy of the escalator 80. The output unit 86 is connected to the joint 72 provided in the power regeneration unit 70.

In the present embodiment, the joint 72 is configured at one end of a cable 74 as an example, and functions as an interface for receiving surplus energy from the escalator 80 via the output unit 86. The joint 72 that is one end of the cable 74 is connected to the output unit 86, and the other end of the cable 74 is connected to the power regeneration unit 70.

The cable 74 is fixed to the mobile body 10A as a whole, and in the second embodiment, the requesting unit 62 causes both of the front display panel 40F and the rear display panel 40R to display, as an example, a sentence “Please connect the joint 72 of the cable 74 to the output unit 86.” via the display control unit 66.

In the present embodiment, the joint 72 is standardized such that the joint 72 can be joined to the output units of a large number of external devices including the escalator 80.

### Action and Effect

Next, an action of the second embodiment will be described.

In the mobile body 10A according to the second embodiment, the main body 12 includes the moving mechanism 54, and the control unit 14 controls the moving mechanism 54 to cause the main body 12 to autonomously travel.

Further, the mobile body 10A according to the second embodiment includes the main body 12, the battery 17, the power regeneration unit 70, and the requesting unit 62. Therefore, when the electric power is insufficient during traveling, the requesting unit 62 requests the owner or a related person of the external device such as the escalator 80 who is the electric power provider to cooperate in the electric power supply, specifically, the display unit 40 is caused to display, as an example, the sentence “Please connect the joint 72 of the cable 74 to the output unit 86.”, whereby the electric power provider supplies the electric power to the battery 17 via the power regeneration unit 70. Note that, the requesting unit 62 may cause the audio output device (not shown) to output, as an example, the sentence “Please connect the joint 72 of the cable 74 to the output unit 86.”

Further, the mobile body 10A according to the second embodiment includes the granting unit 64 that grants an incentive to the electric power provider. Therefore, the electric power provider can receive an incentive by supplying electric power, and thus it is easy to gain cooperation in electric power supply. With the above, the mobile body 10A can be charged during traveling without relying on an expensive system.

Further, the mobile body 10A according to the second embodiment is provided with the power regeneration unit 70 that receives surplus energy generated by the external device such as the escalator 80 and generates regenerative power as the supply unit, whereby the battery 17 can be charged via the external device.

Further, in the mobile body 10A according to the second embodiment, the power regeneration unit 70 includes the joint standardized with the output unit that is provided in the external device generating surplus energy and that outputs the surplus energy. Therefore, surplus energy of public facilities such as various elevators and escalators can be stored through the joint 72.

### Third Embodiment

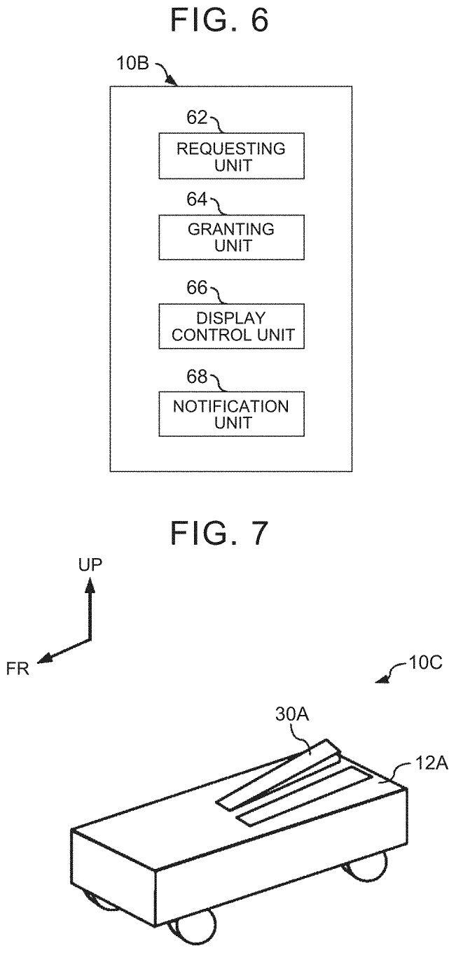

Next, a mobile body 10B according to a third embodiment of the present disclosure will be described with reference to FIG. 6. The same configurations as those of the first embodiment will be described by the same reference symbols, the description thereof will be omitted, and only the different portions will be described in detail. The mobile body 10B according to the third embodiment includes the power regeneration unit 70 as the supply unit, similar to the mobile body 10A of the second embodiment.

The mobile body 10B according to the third embodiment includes a notification unit 68. The notification unit 68 notifies surroundings of a cooperation request for moving the mobile body 10B to the installation location of the external device such as the escalator 80. Specifically, the notification unit 68 causes both of the front display panel 40F and the rear display panel 40R to display, as an example, a sentence “Please move this to the escalator 80 located at XXX.” via the display control unit 66. For the external device to which the mobile body 10B moves, the communication unit 19 receives the information of the external device that is owned by the electric power provider and is closest to the current position from the external server (not shown). Here, the notification unit 68 may output, as an example, the sentence “Please move this to the escalator 80 located at XXX.” using the audio output device (not shown).

### Action and Effect

Next, an action of the third embodiment will be described.

With the mobile body 10B according to the third embodiment, when the battery 17 is exhausted by the time when the mobile body 10B reaches the installation location of the external device such as the escalator 80, the notification unit 68 can request cooperation from the surroundings.

The mobile bodies 10, 10A, and 10B according to the first to third embodiments have been described above. However, it is understood that the mobile bodies 10, 10A, and 10B can be implemented in various modes without departing from the scope of the present disclosure. In the first embodiment, as shown in FIGS. 1 and 2, the configuration in which the pedals 38 are pedaled is adopted as the power generation device 30. However, the present disclosure is not limited to this. For example, as in a mobile body 10C shown in FIG. 7, a power generation device 30A that generates electric power by a stepping motion may be adopted. In this case, the package may be placed on the upper portion of the main body 12A. In addition to the above, a device that generates electric power by the exercise using a running machine may be used, and other various power generation devices that can generate electric power by the exercise of the user can be adopted.

Further, in the mobile body 10 according to the first embodiment, the power generation device 30 is integrally configured with the mobile body 10. However, the present disclosure is not limited to this. For example, a power generation device configured separately from the mobile body 10 may be adopted. In this case, the power generation device is detachably fixed to the mobile body 10 in a state where the power generation device and the battery 17 are connected.

Further, as the mobile body of the present disclosure, the power regeneration unit 70 provided in the mobile body 10A of the second embodiment may be provided in the mobile body 10 according to the first embodiment.

Further, various processors other than the CPU may execute each process that is executed when the CPU 20 shown in FIG. 3 reads and executes the software (program) in the above embodiments. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, each process may be executed by one of these various processors, or a combination of two or more processors of the same type or different types (for example, a combination of multiple FPGAs, a combination of a CPU and an FPGA, and the like). Further, the hardware structure of these various processors is, more specifically, an electric circuit in which circuit elements such as semiconductor elements are combined.

Further, the program described in the embodiments may be recorded on a recording medium such as a compact disc read-only memory (CD-ROM), a digital versatile disc read-only memory (DVD-ROM), and a universal serial bus (USB) memory to be provided. Further, the program may be downloaded from an external device via a network.

The embodiments of the present disclosure have been described as above. However, it is not without saying that the present disclosure is not limited to the above embodiments, and in addition to the above embodiments, the present disclosure can be appropriately modified to be implemented without departing from the scope thereof.

What is claimed is:

1. A mobile body comprising:
a main body provided with a moving function;
a storage battery that is disposed in the main body and that stores electric power for driving the main body;
a supply unit that supplies electric power to the storage battery;
a requesting unit that requests an electric power provider who is able to supply electric power to the storage battery by the supply unit for cooperation in electric power supply; and
a granting unit that grants an incentive to the electric power provider who has supplied the electric power to the storage battery by the supply unit.

2. The mobile body according to claim 1, wherein the supply unit is a power generation device that generates electric power by an exercise of the electric power provider.

3. The mobile body according to claim 1, wherein the granting unit grants the incentive corresponding to the electric power stored in the storage battery.

4. The mobile body according to claim 1, wherein the granting unit grants the incentive corresponding to power consumption.

5. The mobile body according to claim 1, wherein the supply unit is a power regeneration unit that receives surplus energy generated by an external device and generates regenerative power.

6. The mobile body according to claim 5, further comprising a notification unit that notifies surroundings of a cooperation request for moving to an installation location of the external device.

7. The mobile body according to claim 5, wherein the power regeneration unit includes a joint standardized with an output unit that is provided in the external device generating the surplus energy and that outputs the surplus energy.
